(19) United States
(12) Patent Application Publication
(10) Pub. No.: US 2012/0092690 A1
(43) Pub. Date: Apr. 19, 2012

(54) PRINT SETTING APPARATUS, IMAGE FORMING APPARATUS, PRINT PREVIEW DISPLAY METHOD

(75) Inventor: Seiji Saito, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/268,120

(22) Filed: Oct. 7, 2011

Related U.S. Application Data
(60) Provisional application No. 61/392,696, filed on Oct. 13, 2010.
(60) Provisional application No. 61/392,688, filed on Oct. 13, 2010.
(60) Provisional application No. 61/466,665, filed on Mar. 23, 2011.

(51) Int. Cl. G06K 15/02

(52) U.S. Cl. 358/1.13

(57) ABSTRACT

According to one embodiment, a print setting apparatus includes: an input section; a display section configured to display a print preview image on which a predetermine marking is rendered; and a control section configured to acquire, from the input section, a coordinate designated by predetermined operation by a user in a display region of the display section and, if the control section detects that the coordinate moves from a rendering region of the predetermined marking, display the preceding page or the next page of a page currently displayed as the print preview image.

### CROSS-REFERENCE TO RELATED APPLICATIONS

This application is based upon and claims the benefit of priority from: U.S. provisional application 61/392696, filed on Oct. 13, 2010; U.S. provisional application 61/392688, filed on Oct. 13, 2010; and U.S. provisional application 61/466665, filed on Mar. 23, 2011; the entire contents all of which are incorporated herein by reference.

### FIELD

Embodiments described herein relate generally to a technique for setting an image forming apparatus carried out when printing is performed.

### BACKGROUND

In the past, there is a driver program and an image forming apparatus that display a print preview screen for causing a user to check a printing state and displays a screen for performing various kinds of setting for duplex printing, simplex printing, and the like.

However, when the user switches display from a currently-displayed page to the next page, the preceding page, or the like using the print preview screen in the past, operation is not intuitive.

### DESCRIPTION OF THE DRAWINGS

FIG. 1 is a diagram of a configuration example of an image forming apparatus;

FIG. 2 is a block diagram of the image forming apparatus;

FIG. 3 is a flowchart for explaining an operation example of the image forming apparatus;

FIG. 4 is a diagram of a display example in an interface section in first, second, and third embodiments;

FIG. 5 is a flowchart for explaining an operation example in the first embodiment;

FIGS. 6A and 6B are diagrams of an example of setting operation in the first embodiment;

FIGS. 7A and 7B are diagrams of display examples performed when a sheet turning direction is set as upward opening;

FIGS. 8A and 8B are diagrams for explaining a problem in changing the sheet turning direction from a left opening state to an upward opening state;

FIG. 9 is a diagram of a display example of a state in which an image direction is adjusted to a regular direction when the sheet turning direction is changed from the left opening state to the upward opening state;

FIGS. 10A and 10B are diagrams of operation examples in setting the sheet turning direction;

FIG. 11 is a diagram of a configuration example in which a PC and a tablet PC are print setting apparatuses;

FIG. 12 is a diagram of an example of initial display in a second embodiment;

FIG. 13 is a flowchart for explaining an operation example in the second embodiment;

FIGS. 14A, 14B, and 14C are diagrams of display examples during operation in the second embodiment;

FIG. 15 is a flowchart for explaining an operation example in a third embodiment;

FIGS. 16A and 16B are diagrams of display examples during operation in the third embodiment; and

FIG. 17 is a diagram of an operation example in arranging an image in the third embodiment.

### DETAILED DESCRIPTION

In general, according to one embodiment, a print setting apparatus includes: an input section; a display section configured to display a print preview image on which a predetermined marking is rendered; and a control section configured to acquire, from the input section, a coordinate designated by predetermined operation by a user in a display region of the display section and, if the control section detects that the coordinate moves from a rendering region of the predetermined marking, display the preceding page or the next page of a page currently displayed as the print preview image.

In a first embodiment explained below, there is provided a user interface that can intuitively operate a printing target image layout in preview display during printing. In second and third embodiments, in addition to the form of the first embodiment, there is provided a user interface that simultaneously performs print setting for simplex and duplex printing using a print preview screen.

### First Embodiment

The form of the first embodiment is explained below with reference to the drawings.

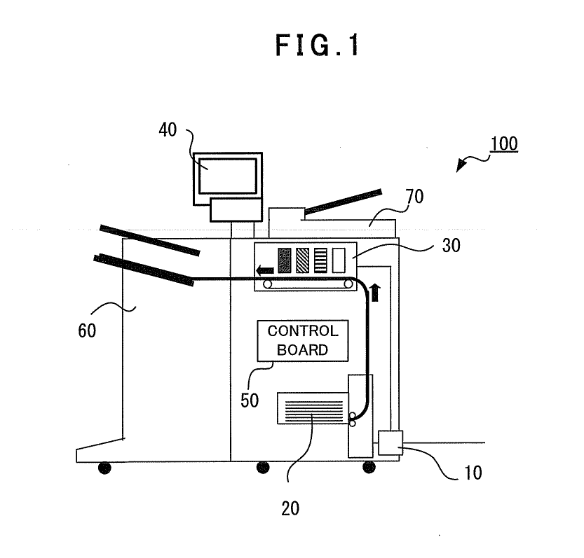

An example of a hardware configuration of an image forming apparatus according to the first embodiment is shown in FIG. 1. An image forming apparatus 100 includes an external-information input section 10, a sheet storing section 20, a printing section 30, an interface section 40, a control board 50, a finishing apparatus 60, and a reading section 70.

The external-information input section 10 is a unit configured to receive printing data created by an external apparatus such as a personal computer (hereinafter referred to as PC). The external-information input section 10 includes a network interface card. The sheet storing section 20 is a unit configured to store sheets and convey sheets stored in a main body section of the image forming apparatus 100. The sheet storing section 20 includes a pickup roller and a tray.

The printing section 30 is a unit configured to form images of colors C (cyan), M (magenta), Y (yellow), and K (black) on a sheet conveyed from the sheet storing section 20. The printing section 30 forms, on the sheet, an image of printing target data input from the external-information input section 10 or image data of an original document read by the reading section 70. The printing section 30 includes, for each of the colors, a process unit including a photoconductive drum and a charging roller.

The interface section 40 is a control panel configured to display a state of the image forming apparatus 100 and a progress state of a job to a user and acquire an instruction and setting from the user. In the interface section 40, a liquid crystal panel is used as a display section and an input device of a touch panel type mounted with a touch sensor is used as an input section.

The control board 50 is a board configured to collectively control respective kinds of hardware in the image forming apparatus 100. The finishing apparatus 60 is an apparatus configured to execute, on the basis of setting by the user, processing for binding, with staples, a bundle of sheets on which images are formed (stapling) and processing for opening holes in the same positions in plural sheets (hole punching). The finishing apparatus 60 includes at least a stapling device and a puncher device.

The reading section 70 is a unit configured to scan an image drawn on a sheet arranged on a transparent tray and convert the image into image data. The reading section 70 includes at least the transparent tray on which a printing target sheet is placed, a light emitting device, and a CCD image sensor (Charge Coupled Device Image Sensor). The reading section 70 may include an auto document feeder as shown in FIG. 1.

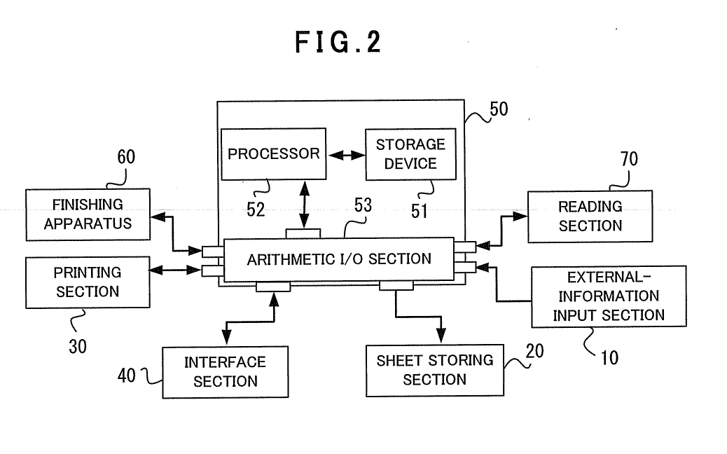

The configuration of the control board 50 is explained with reference to FIG. 2. The control board 50 includes a storage device 51, a processor 52, and an arithmetic I/O section 53. The storage device 51 is a device configured to store various data and a computer program. The storage device 51 includes, for example, a RAM (Random Access Memory) , a ROM (Read Only Memory), a DRAM (Dynamic Random Access Memory), an SRAM (Static Random Access Memory), a VRAM (Video RAM), or a hard disk drive. The processor 52 is an arithmetic processing device configured to execute an arithmetic operation of the computer program stored in the storage device 51 to control the respective kinds of hardware in the image forming apparatus 100. The processor 52 is, for example, a CPU (Central Processing Unit) or an MPU (Micro Processing Unit).

The arithmetic I/O section 53 is a data bus configured to control data communication among the respective kinds of hardware in the image forming apparatus 100. A control signal and data from the processor 52 are transmitted to the hardware through the arithmetic I/O section 53.

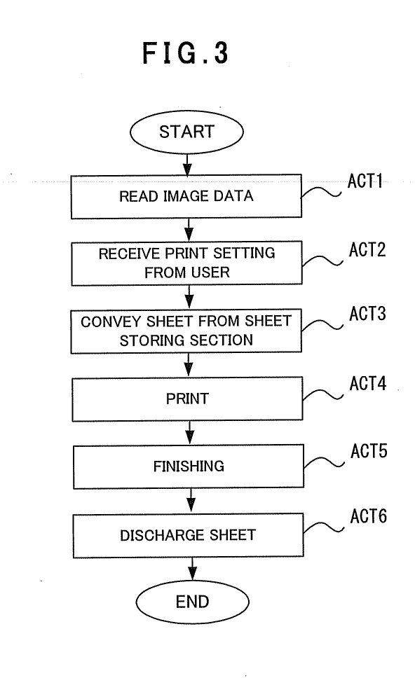

FIG. 3 is a flowchart for explaining an operation example of the image forming apparatus 100. The external-information input section 10 acquires printing job information including printing target image data from an external apparatus. The acquired image data is stored in the storage device 51 through the arithmetic I/O section 53 according to the control by the processor 52 (ACT 1). The image data may be data scanned from a sheet by the reading section 70.

Subsequently, the interface section 40 receives information concerning print setting (the number of prints, selection of monochrome or color, designation of stapling or hole punching, duplex or simplex printing setting, etc.) from the user (ACT 2). An example of the operation in ACT 2 is explained in detail later.

After the information concerning the print setting from the user is acquired, the sheet storing section 20 conveys sheets stored therein to the main body section (ACT 3). The printing section 30 forms an image of the image data read in ACT 1 on the conveyed sheets (ACT 4). The printing section 30 forms the image on the sheets on the basis of the printing job information.

If there is setting of stapling or hole punching concerning the printing job, the finishing apparatus 60 applies finishing such as stapling or hole punching to a printed sheet bundle (ACT 5). Thereafter, the sheets are discharged (ACT 6).

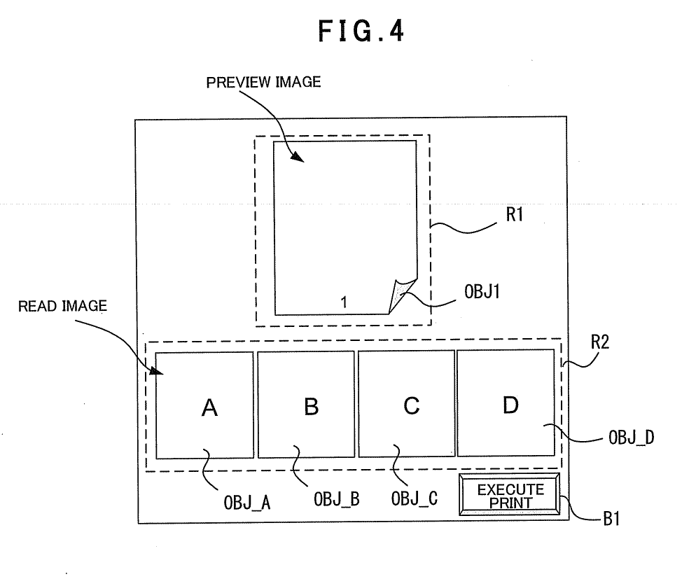

An operation during the setting in ACT 2 is explained below. FIG. 4 is an example of a setting screen displayed by the interface section 40. As shown in FIG. 4, the interface section 40 includes a print preview image display region R1 (hereinafter referred to as region R1) and a read image display region R2 (hereinafter referred to as region R2). In FIG. 4, broken lines are not displayed actually.

An image indicating a state of a sheet after printing is displayed in the region R1. In an example shown in FIG. 4, an image simulating a sheet (hereinafter referred to as preview image) is displayed in the region R1. However, two or more preview images may be displayed.

In the region R2, read images obtained by reducing printing target images acquired in ACT 1 are displayed as a list. In the example shown in FIG. 4, four images are acquired as the printing target images in ACT 1. The interface section 40 displays images OBJ_A to OBJ_D obtained by reducing these images in the region R2 as a list.

Among the images displayed in the region R2, an arbitrary image is touched (this operation by the user is hereinafter referred to as “selection” according to necessity). When the image is carried to the region R1 and a fingertip is separated from the touch panel (this operation by the user is hereinafter referred to as “release”), the selected image is drawn on the preview image in the region R1. This display control is performed by the processor 52 such that the processor 52 acquires a coordinate acquired from the input section of the interface section 40 and detects that the coordinate moves from image regions (the regions of OBJ_A to OBJ_O) of the list to the region R1.

If a marking OBJ1 (a predetermined marking) for page turning rendered on the preview image is moved in the left direction or the upward direction while being touched by the fingertip of the user or a pen nib, a preview image of the next page is displayed in the region R1. On the other hand, if the marking OBJ1 is moved in the right direction or the downward direction, a sheet of the preceding page is displayed in the region R1. The display control for page turning is explained later.

Concerning a preview image after the page turning, similarly, an image in the region R2 is selected and released on the preview image in the region R1, whereby the selected image is drawn on the preview image. According to this display control, the user can intuitively perform arrangement setting for an image and page turning.

If a print execution button B1 is pressed, respective kinds of setting are decided. The processor 52 writes a layout of the image arranged on the preview image and various setting values of simplex printing, duplex printing, and the like in the printing job information. The printing section 30 executes printing to match the image data and the setting information included in the decided printing job information.

A preview image for display, reduced images, and coordinate information of a display position shown in FIG. 4 are stored in the storage device 51. The display on the interface section 40 is controlled by the processor 52 such that the processor 52 executes an arithmetic operation of a predetermined rendering program or display control program.

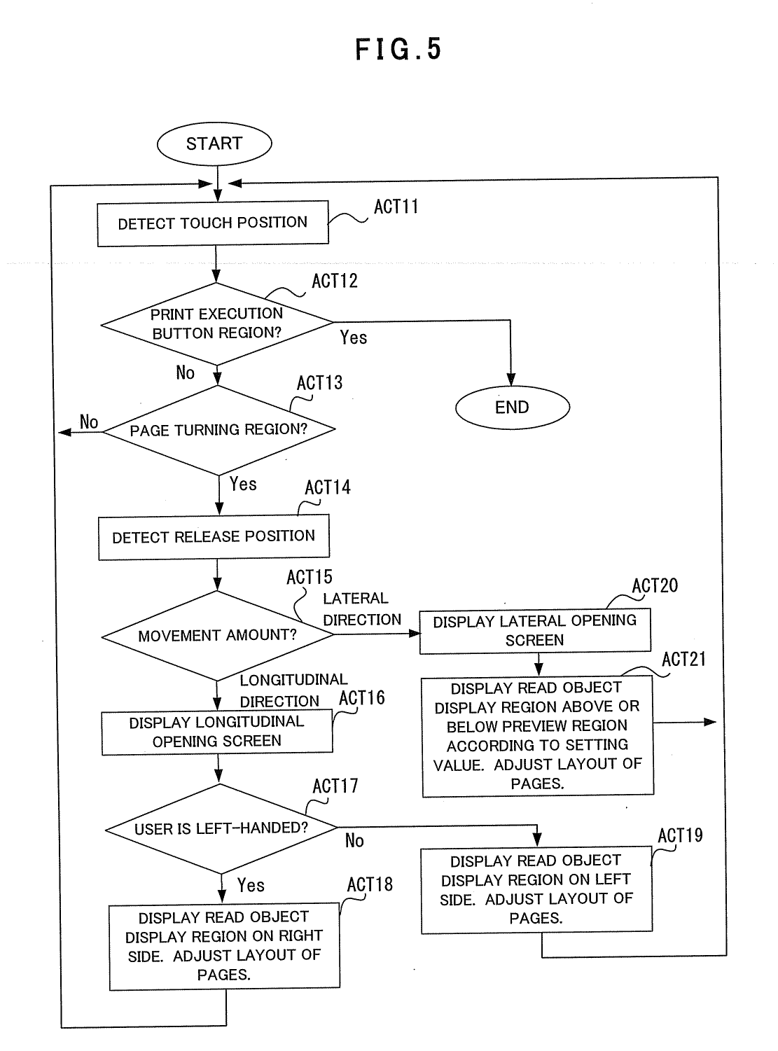

A sheet turning operation is explained below with reference to a flowchart of FIG. 5.

The processor 52 detects a position sensed by the touch sensor of the interface section 40 (a position touched by the user on a display screen) (ACT 11). This detection is performed by the processor 52 such that the processor 52 acquires coordinate information of a coordinate touched by the user from the interface section 40.

The processor 52 determines whether a display region of the print execution button B1 is selected (ACT 12). If the region of the print execution button B1 is selected (Yes in ACT 12), the processor 52 decides information set by the user and writes the decided setting information in the printing job information. The setting processing ends and processing in ACT 3 and subsequent acts in FIG. 3 is performed on the basis of the printing job information. On the other hand, if the touch position is not the region of the print execution button B1 (No in ACT 12), the processing proceeds to ACT 13.

Subsequently, the processor 52 determines whether a page turning region, i.e., a display region of the marking OBJ1 is selected (ACT 13). If the display region of the marking OBJ1 is selected (Yes in ACT 13), the processor 52 detects a release position (ACT 14). This detection is performed by the processor 52 such that the processor 52 acquires, from the interface section 40, coordinate information of a coordinate where the fingertip of the user separates from the touch panel.

The processor 52 calculates differences in the vertical and horizontal directions between a coordinate value of the touch position in ACT 11 and a coordinate value of the release position in ACT 14 and acquires a movement amount of the fingertip (ACT 15). If the difference in the horizontal direction is larger than the difference in the vertical direction, the processor 52 determines that the fingertip is moved in the lateral direction. If the difference in the vertical direction is larger than the difference in the horizontal direction, the processor 52 determines that the fingertip is moved in the longitudinal direction.

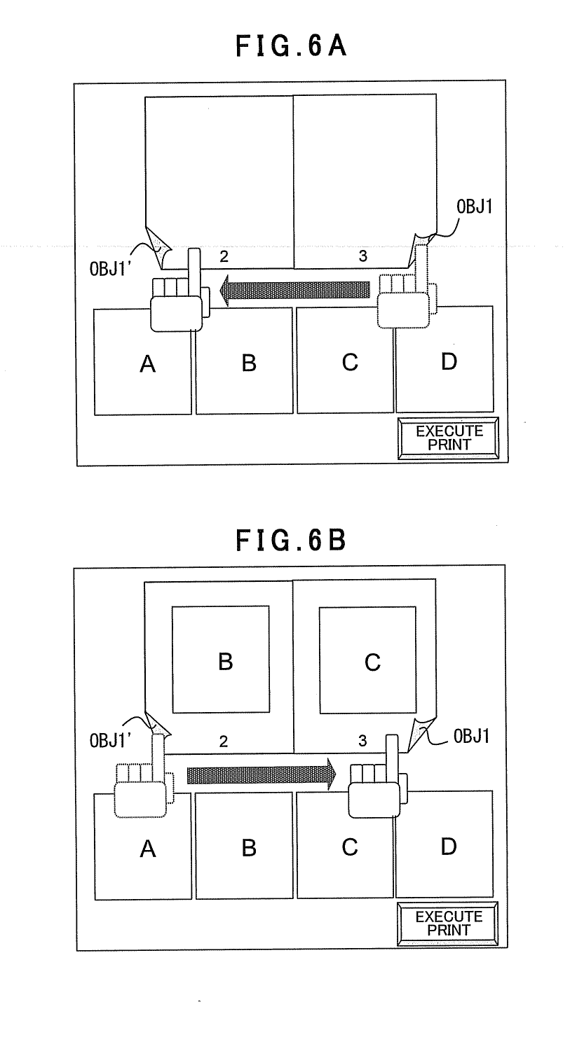

If it is determined that the fingertip is moved in the lateral direction (lateral direction in ACT 15), the processor 52 displays the next page of a page currently displayed as the print preview image and controls the display such that the print preview image changes to a lateral opening state (ACT 20). A screen state at this point is shown in FIG. 6A. FIG. 6A is a display example performed when ACT 20 is executed in the display state shown in FIG. 4. If the marking OBJ1 is touched in the display state shown in FIG. 4 and the fingertip is moved in the left lateral direction, the next page is displayed in the user interface section 40 and a sheet is displayed in the lateral opening state. If a marking OBJ1′ (a predetermined marking) is touched by the user and the fingertip is moved in the right lateral direction as shown in FIG. 6B, the immediately preceding page is displayed, i.e., in this example, the screen state returns to the state shown in FIG. 4.

An implementation may be adopted in which a display position of a read image and a display position of a preview image are vertically changed according to setting values of login data (information set in advance individually for the user) (ACT 21). In the example shown in FIGS. 6A and 6B, the user interface section 40 displays the preview image and the read image with the region R1 set in the upper position and the region R2 set in the lower position. However, the preview image and the read image may be displayed with the region R1 set in the lower position and the region R2 set in the upper position. The login data is data acquired on the basis of a user ID in the printing job information or a user ID obtained from a predetermined login screen displayed in the interface section 40. The login data is stored in the storage device 51 beforehand in association with the user ID.

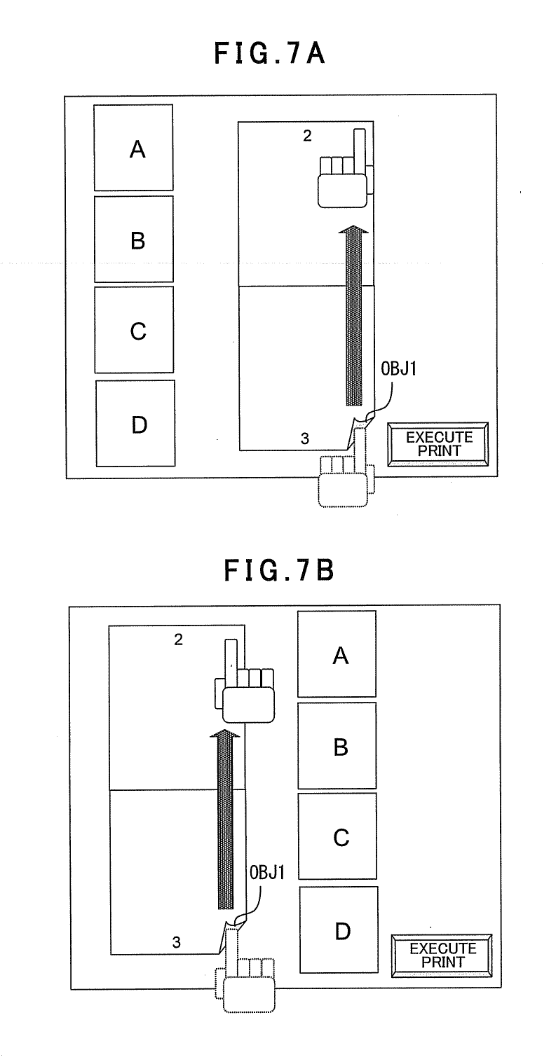

On the other hand, if it is determined that the fingertip is moved in the longitudinal direction (longitudinal direction in ACT 15), the processor 52 performs control to display a longitudinal opening screen shown in FIGS. 7A and 7B (ACT 16).

Subsequently, the processor 52 acquires dominant hand information of the user from the login data or the like and determines whether the user is left-handed (ACT 17). If the user is left-handed (Yes in ACT 17), as shown in FIG. 7A, the processor 52 performs display control such that the display region R1 of the preview image is set on the right side and the display region R2 of the read image is set on the left side (ACT 18). If the user is not left-handed (No in ACT 17), as shown in FIG. 7B, the processor 52 performs display control such that the display region R1 of the preview image is set on the left side and the display region R2 of the read image is set on the right side (ACT 19). If the user is left-handed, the user more smoothly moves the armor the fingertip from the left side to the right side. Conversely, if the user is right-handed, the user more smoothly moves the arm or the fingertip from the right side to the left side. The switching of the display according to the dominant hand makes it easy to perform operation for touching the read image and releases the read image on the preview image.

After the processing in ACT 18, ACT 19, and ACT 21 ends and if the page turning region is not selected in ACT 13 (No in ACT 13), the processing returns to ACT 11.

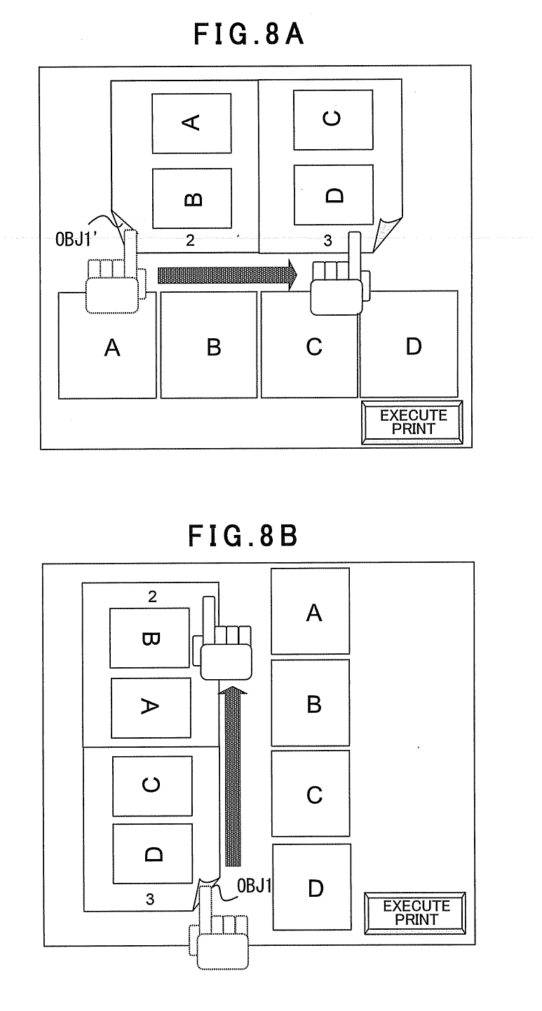

In this embodiment, setting of N in 1 for arranging plural (N) read images on one sheet is also possible. However, as shown in FIG. 8A, if, after arrangement setting for the read images is performed in the lateral opening state, the fingertip is moved in an arrow direction to once return a page to the original page (to the first page as shown in FIG. 4) and then the lateral opening state is changed to a longitudinal opening state, as shown in FIG. 8B, the order of OBJ_A and OBJ_B on a preview image of a second page is vertically reversed and the direction of OBJ_A and OBJ_B and the direction of OBJ_C and OBJ_D are arranged in different directions. If, after the arrangement setting for the read images is performed in the longitudinal opening state, the longitudinal opening state is changed to the lateral opening state, the same problem occurs. In order to solve this problem, if, after the arrangement of the read images is performed, an opening direction of a page is changed, concerning an even number page (in the case of duplex printing, a rear page of a sheet), the processor 52 performs adjustment as explained below.

The arrangement order of the read images is adjusted to be vertically reversed.

The direction of the read images is rotated 180°.

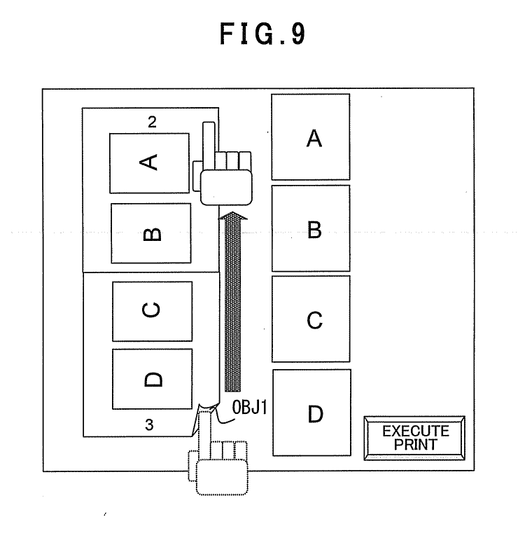

Consequently, as shown in FIG. 9, the read images are arranged in regular order and laid out in the same direction. The processor 52 performs the adjustment as well in ACT 18, ACT 19, and ACT 21.

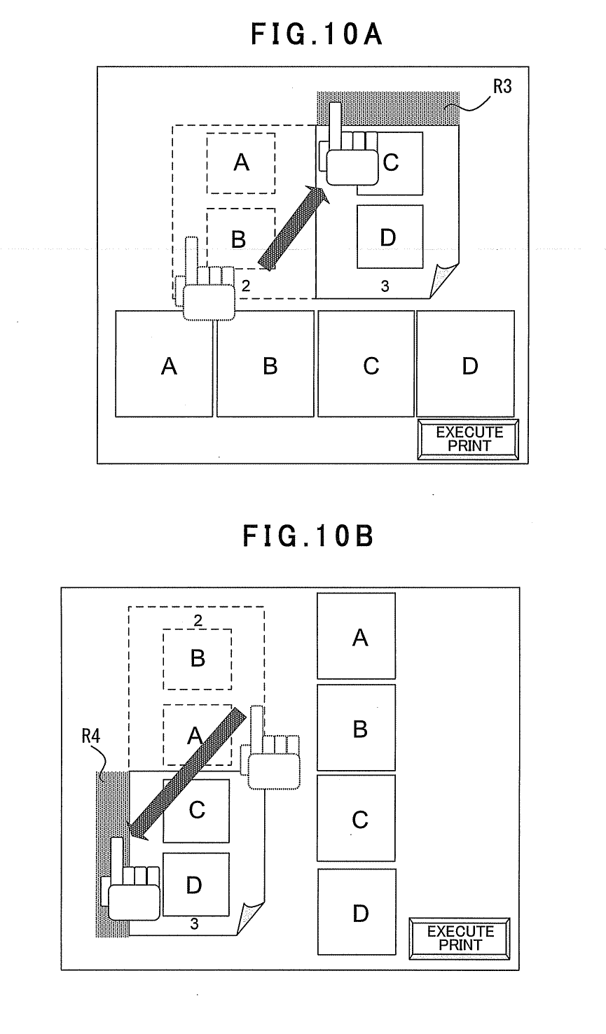

Concerning a change of an opening direction of a sheet, other implementation examples are explained with reference to FIGS. 10A and 10B. In this embodiment, in a state in which a page is opened in the lateral opening state and a preview image for two pages is displayed, if a touch position is a preview image region of an arbitrary page and a release position is above the next page, the processor 52 performs display control such that the lateral opening state is changed to the longitudinal opening state. An example in which lateral opening is changed to longitudinal opening is shown in FIG. 10A. If a preview image of a second page is touched and released in a region R3 above a preview image of a third page, the processor 52 arranges the preview image of the second page above the third page to perform display control such that the lateral opening state is changed to the longitudinal opening state (a state shown in FIG. 10B).

On the other hand, in the state shown in FIG. 10B, if the preview image of the second page is touched and released in a left side region R4 of the third page, the processor 52 arranges the preview image of the second page on the left side of the third page to perform display control such that the longitudinal opening state is changed to the lateral opening state (a state shown in FIG. 10A).

Similarly, in the lateral opening state, if the preview image of the third page is arranged below the second page, the lateral opening state is changed to display in the longitudinal opening state. In the longitudinal opening state, if the preview image of the third page is arranged on the right side of the second page, the longitudinal opening state is changed to display in the lateral opening state.

It may be configured such that, in order to suppress occurrence of inconsistency of arrangement, an opening state cannot be changed to the longitudinal or lateral opening unless a page is always returned to the first page. In the example explained in this embodiment, right-handedness and left-handedness are identified using the login data. However, for example, a method of designating a dominant hand through an input of a button or a method of recognizing a dominant hand using a camera or the like may be adopted. In the implementation example explained in this embodiment, the user touches a read image with the fingertip and moves the read image. However, an implementation may be adopted in which a button is displayed and a read image is arranged on a print preview image by button operation.

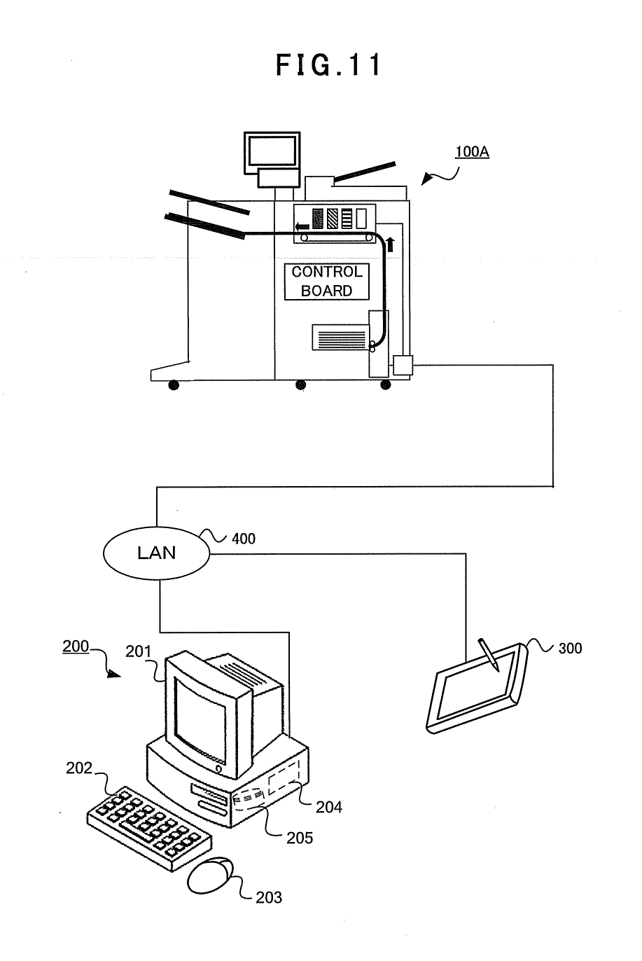

In the above explanation, the configuration including the interface section 40 and the control board 50 in the image forming apparatus 100 is explained as the print setting apparatus. However, as shown in FIG. 11, a PC 200 connected to an image forming apparatus 100A in the past via a LAN (Local Area Network) 400 can also be applied as the print setting apparatus. In other words, operations same as those explained above can be realized using a CPU 204, a memory 205, a monitor 201, which is a display section, and a keyboard 202 and a mouse 203, which are input sections, of the PC 200. Naturally, the embodiment can also be applied to a tablet PC 300 including a CPU, a memory, and a display of a touch panel type. When the form of the first embodiment is applied, a user interface is different from that in the past. However, as a data structure of setting information, printing job information, and the like, a telegraphic message format same as that in the past can be applied. Therefore, even when the PC 200 or the tablet PC 300 is used as a client apparatus (a print setting apparatus) for print setting, since printing job information and setting information to be transmitted adopt a format in the past, the image forming apparatus 100A in the past can be directly applied. The LAN 400 may be either a wired or wireless LAN.

### Second Embodiment

In the second embodiment, there is provided a user interface that can intuitively and plainly set simplex and duplex printing and white paper insertion with a small number of times of operation. Components and operations other than matters explained below are the same as those in the first embodiment. Therefore, explanation of the components and the operations is omitted (see FIGS. 1 to 3 and 11). The print preview image display region R1, the read image display region R2, the marking OBJ1, the read images OBJ_A to OBJ_D, and the print execution button B1 are also the same as those in the first embodiment.

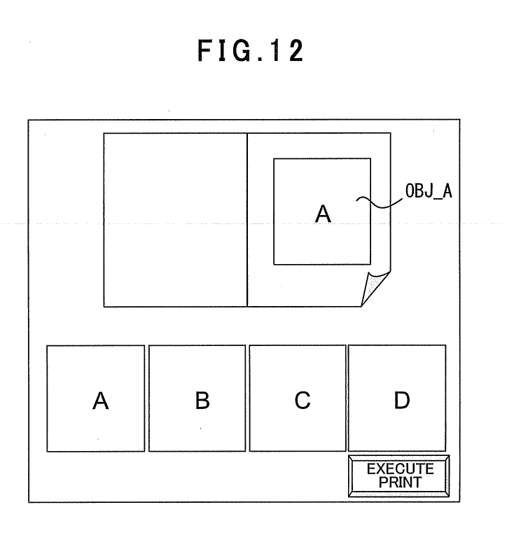

An example of an initial screen displayed by the user interface section 40 is shown in FIG. 12. In this example, a state in which OBJ_A is arranged in a preview image on the right side in a state in which an arbitrary page is opened in lateral opening is an initial state. As in the first embodiment, in the following explanation, it is assumed that page turning is left opening and a page number on the left side is smaller than a page number on the right side by one.

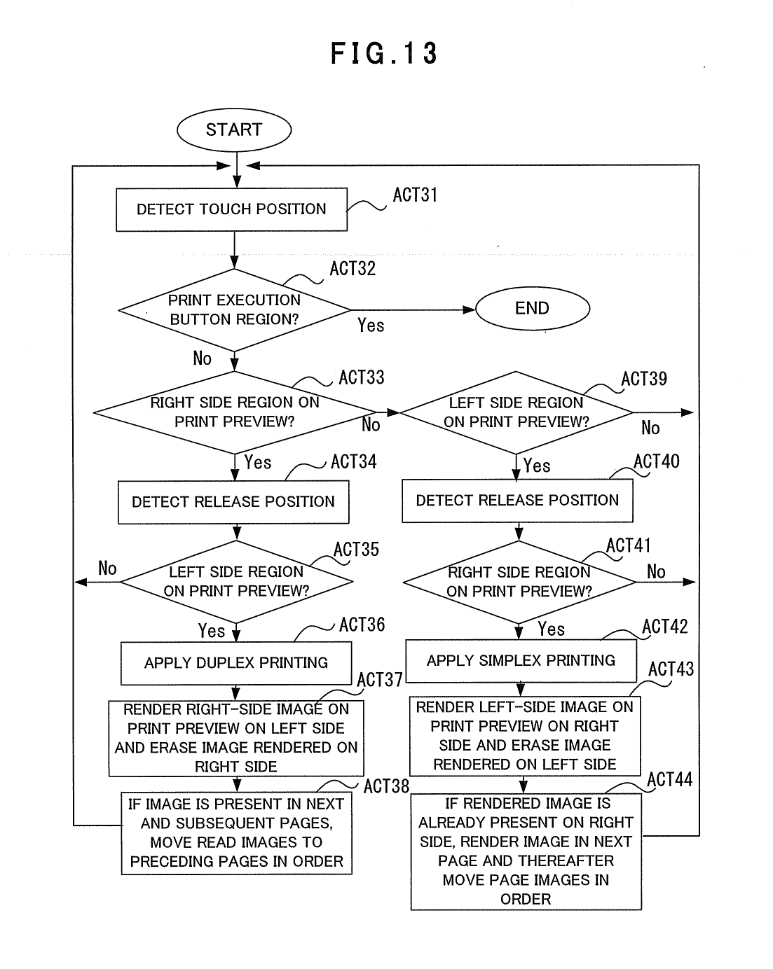

An operation in this embodiment is explained with reference to a flowchart of FIG. 13.

The processor 52 detects a touch position of a user as in the first embodiment (ACT 31). The processor 52 determines whether a touched region is the region of the print execution button B1 (ACT 32). If the touched region is the region of the print execution button B1 (Yes in ACT 32), the print setting processing ends and the processing in ACT 3 and subsequent acts in FIG. 3 is executed.

Subsequently, the processor 52 determines whether the touched region is a region of a preview image on the right side in the region R1 (ACT 33). If the touched region is the region of the preview image on the right side (Yes in ACT 33), the processor 52 detects a release position (ACT 34). If the release position is a region of a preview image on the left side in the region R1 (Yes in ACT 35), the processor 52 applies setting for forming an image on the rear side of a sheet as well, i.e., setting of duplex printing and temporarily writes a setting value indicating the duplex printing in the storage device 51 (ACT 36).

The processor 52 renders, on the preview image on the left side, a read image arranged in the preview image region on the right side and erases a read image arranged on the preview image on the right side (ACT 37). If a read image is already arranged on preview images in the next and subsequent pages, the processor 52 arranges read images in preceding pages in order (Act 38).

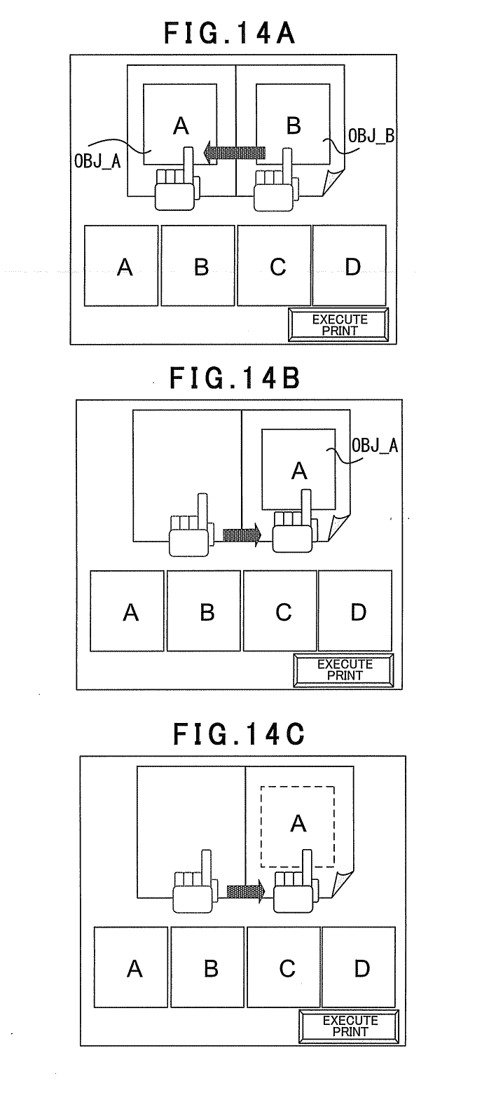

An operation example and a display example in performing the operations in ACT 37 and ACT 38 are shown in FIG. 14A. If the right-side preview region is selected in the initial state (see FIG. 12) and released on the left-side preview area, OBJ_A rendered on the preview image on the right side is moved onto the preview image on the left side. Since OBJ_A is moved onto the preview image having a smaller page number, another object (in this example, OBJ_B) already rendered in the following page is also moved onto a preview image having a smaller page number. In FIG. 14A, next object (in this example, OBJ_B) is rendered on the preview image on the right side. At this point, the operation is treated as setting of the duplex printing.

Referring back to the flowchart of FIG. 13, if the touched region is not the region of the preview image on the right side in the region R1 in ACT 33 (No in ACT 33) , the processor 52 determines whether the touched region is the region of the preview image on the left side in the region R1 (ACT 39). If the touched region is the region of the preview image on the left side (Yes in ACT 39), the processor 52 detects a release position (ACT 40). If the release position is the region of the preview image on the right side in the region R1 (Yes in ACT 41), the processor 52 applies setting of simplex printing and temporarily writes a setting value indicating the simplex printing in the storage device 51 (ACT 42).

Subsequently, the processor 52 renders, on the preview image on the right side, a read image arranged on the preview image on the left side and erases a read image arranged in the region of the preview image on the left side (ACT 43). If read images are arranged in pages preceding the touched preview image, the processor 52 controls the read images to be arranged in the following pages in order (ACT 44).

An operation example and a display example in performing the operations in ACT 43 and ACT 44 are shown in FIG. 14B. If the region of the preview image on the left side is selected by the user in a state shown in FIG. 14A and released on the preview image on the right side, OBJ_A rendered on the preview image on the left side is rendered on the preview image on the right side. Since OBJ_A is moved onto the preview image having a page number larger by one, another object (in this example, OBJ_B) is also moved onto a preview image having a page number larger by one. At this point, the operation is treated as setting of the simplex printing.

In a state shown in FIG. 14B, i.e., a state in which no image is present on the preview image on the left side, if the region of the preview image on the left side is further touched and released on the preview image on the right side, as shown in FIG. 14C, a sheet of white paper having no image drawn thereon is inserted into the preview image on the right side. At this point, OBJ_A is moved onto a preview image having the next page number. In FIG. 14C, broken lines and symbol “A” indicated on the preview image are not displayed actually. Other images are also arranged on preview images having the following page numbers in order.

If the processing in ACT 38 and ACT 44 is completed or if the determination result in ACT 35, ACT 39, or ACT 41 are negative, the processing returns to ACT 31.

If the print execution button B1 is touched after the duplex printing or the simplex printing is set as explained above (ACT 32), the processor 52 writes the setting value of the duplex or simplex printing temporarily stored in the storage device 51 in the printing job information. When the printing section 30 performs print processing, the setting of the duplex or simplex printing is reflected.

In the above explanation, it is assumed that a page turning direction is the left opening direction. However, the embodiment can also be applied to an upward opening direction and a right opening direction. In the above explanation, the setting of the duplex printing and the simplex printing and the user interface for the operation are referred to. It is also possible to adopt a form in which the user interface for page turning in the first embodiment and the user interface for operation of the duplex printing and the simplex printing in this embodiment are combined.

### Third Embodiment

In the third embodiment, there is provided a user interface that can intuitively and plainly set duplex printing with a small number of times of operation by setting the duplex printing and simplex printing according to a released page (odd number page or even number page). Components and operations other than matters explained below are the same as those in the first embodiment. Therefore, explanation of the components and the operations is omitted (see FIGS. 1 to 3 and 11). The print preview image display region R1, the read image display region R2, the marking OBJ1, the page images OBJ_A to OBJ_D, and the print execution button B1 are also the same as those in the first embodiment.

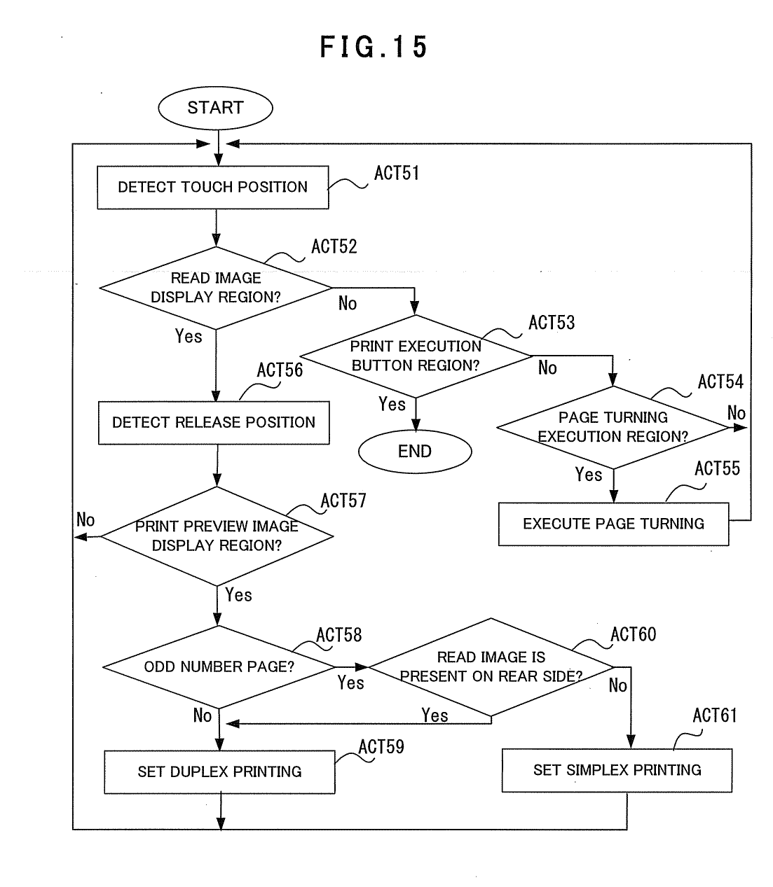

An operation in this embodiment is explained with reference to a flowchart of FIG. 15. Initial display of the interface section 40 is in the state shown in FIG. 4.

As in the first embodiment, the processor 52 detects a touch position of a user (ACT 51). The processor 52 determines whether a touched region is the region R2 (ACT 52). If the touched region is not the region R2 (No in ACT 52), the processor 52 determines whether the touched region is the region of the print execution button B1 (ACT 53). If the touched region is the region of the print execution button B1 (Yes in ACT 53), the print setting processing ends and the processing in ACT 3 and subsequent acts in FIG. 3 is executed.

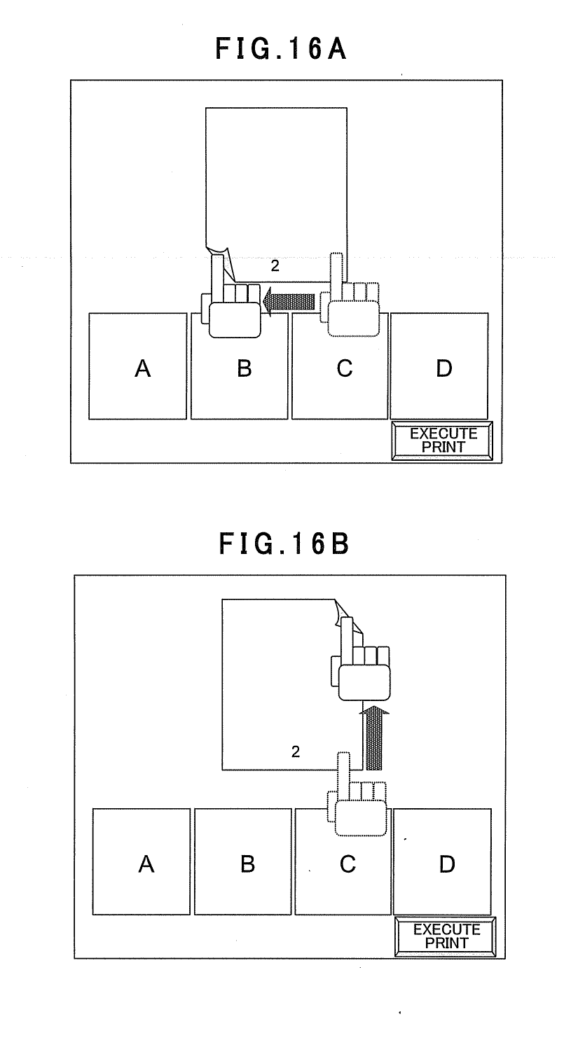

If the touched region is not the region of the print execution button B1 (No in ACT 53), the processor 52 determines whether the touched region is a page turning region, i.e., the region of the marking OBJ1 (ACT 54). If the touched region is the region of the marking OBJ1 (Yes in ACT 54), the processor performs control to display the next page of a currently-displayed page (ACT 55). A display example of lateral opening in this embodiment is shown in FIG. 16A. A display example of longitudinal opening in this embodiment is shown in FIG. 16B. In the first embodiment, when page turning is performed, a preview image for two pages is displayed. However, a preview image for only one page may be displayed as in this embodiment. The display is changed to longitudinal opening or lateral opening according to a moving direction of a fingertip as in the first embodiment. It is also possible to return the preview image to the preceding page.

Referring back to ACT 52, if the touched region is the region R2 (Yes in ACT 52), the processor 52 controls display such that a selected read image is moved in association with the movement of the fingertip. The processor 52 detects a release position (ACT 56) and determines whether the release position is in the region R1 (ACT 57). If the release position is in the region R1 (Yes in ACT 57), the processor 52 determines whether a preview image currently displayed in the region R1 is an odd number page (ACT 58). If the preview image is an even number page (No in ACT 58), the processor 52 renders the selected read image on the preview image displayed in the region R1 and temporarily stores a setting value of the duplex printing in the storage device 51 to perform setting of the duplex printing (ACT 59). On the other hand, if the preview image is an odd number page (Yes in ACT 58), the processor 52 determines whether a read image is already arranged on a preview image equivalent to the rear side of a currently-displayed sheet (ACT 60). If a read image is already arranged on the rear side (Yes in ACT 60), the processor 52 performs the setting of the duplex printing (ACT 59). If a read image is not arranged on the rear side (No in ACT 60), the processor 52 renders the selected read image on the preview image currently displayed in the region R1 and temporarily stores a setting value of the simplex printing in the storage device 51 to perform setting of the simplex printing (ACT 61).

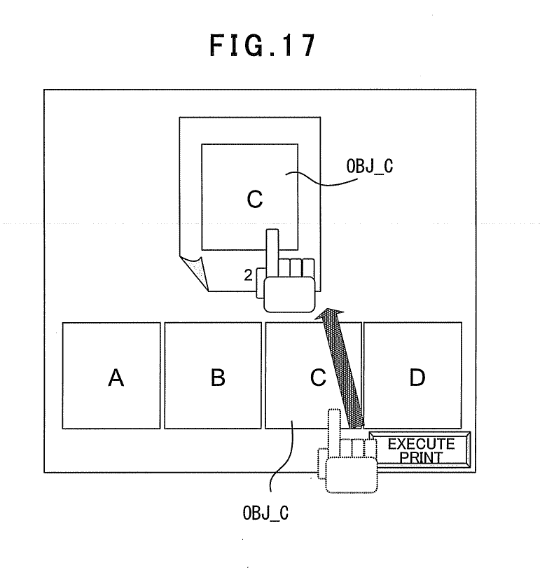

FIG. 17 is a diagram of a state in which a read image (OBJ_C) is released on an even number page. In this embodiment, the setting of the duplex printing is performed simultaneously with an object being released on an even number page.

After the processing in ACT 59 and ACT 61 is performed, the processing returns to ACT 51. Thereafter, if the region of the print execution button B1 is touched (Yes in ACT 53), the processor 52 writes, in the printing job information, the setting value of the duplex printing or the setting value of the simplex printing stored in the storage device 51 and decides the setting of the duplex or simplex printing. The setting of the duplex or simplex setting is reflected during printing.

By applying the first to third embodiments, it is possible to provide an intuitively plain layout setting environment. By applying the second and third embodiments, operation for setting the duplex printing and the simplex printing is facilitated. This makes it possible to provide a more intuitively plain setting environment than the setting in the past having a hierarchical structure. A setting screen in the past is a layout in which plural tabs such as “basic setting”, “finishing”, and “image quality” are arranged in a row in an upper part of one print setting dialog and the tabs are switched to switch most of the display regions in the dialog. If the user performs screen setting using the setting screen in the past, the user needs to press the tab for finishing and check a checkbox for duplex printing setting in the tab. This operation is complicated. The user needs to remember that the setting of the duplex printing and the simplex printing is present in the finishing tab. In general, in the setting dialog in performing printing, information in the tab of the basic setting is displayed in the beginning and the setting of the duplex printing and the simplex printing is not displayed. Therefore, if a frequency of use is not high, work for searching for a setting screen every time is performed. By applying the form of the embodiments, the user can display a print preview and perform, using the print preview screen, print setting for the duplex printing and the simplex printing without particularly being aware of the print setting.

As explained above in detail, according to the technique described in this specification, it is possible to easily operate page turning on a preview screen.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A print setting apparatus comprising:
an input section;
a display section configured to display a print preview image on which a predetermine marking is rendered; and
a control section configured to acquire, from the input section, a coordinate designated by predetermined operation by a user in a display region of the display section and, if the control section detects that the coordinate moves from a rendering region of the predetermined marking, display a preceding page or a next page of a page currently displayed as the print preview image.

2. The apparatus according to claim 1, wherein
the display section further displays a list of printing target images, and
if the control section detects that the coordinate acquired from the input section moves from a region of a printing target image in the list to the print preview image region, the control section renders the printing target image on the print preview image.

3. The apparatus according to claim 2, wherein, if a page of a currently-displayed print preview image, which is a print preview image on which a printing target image is rendered, is an even number page, the control section performs setting of duplex printing.

4. The apparatus according to claim 2, wherein, if a page of a currently-displayed print preview image, which is a print preview image on which a printing target image is rendered, is an odd number page and a printing target image is not rendered on a print preview image equivalent to a rear side of the currently-displayed print preview image, the control section performs setting of simplex printing.

5. The apparatus according to claim 1, wherein, if the control section detects that the coordinate moves to above or below the rendering region of the predetermined marking, the control section controls display to display the print preview image in a longitudinal opening state and, if the control section detects that the coordinate moves to a left direction or a right direction of the rendering region of the predetermined marking, the control section controls display to display the print preview image in a lateral opening state.

6. The apparatus according to claim 1, wherein
the display section further displays a list of printing target images, and
the control section further acquires information concerning a dominant hand of the user and controls, on the basis of the dominant hand information, display positions of the print preview image and the list to be different.

7. The apparatus according to claim 1, wherein, if a print preview image for two pages in a printing target sheet is displayed in a lateral opening state and if the control section detects that the coordinate moves from a display region of one page of the two pages to above or below a display region of the other page, the control section further controls display to display the print preview image in a longitudinal opening state.

8. The apparatus according to claim 1, wherein, if a print preview image for two pages in a printing target sheet is displayed in a longitudinal opening state and if the control section detects that the coordinate moves from a display region of one page of the two pages to a right side or a left side of a display region of the other page, the control section further controls display to display the print preview image in a lateral opening state.

9. The apparatus according to claim 1, wherein, if a print preview image of an arbitrary page and a next page of the arbitrary page is displayed in an open state and if the control section detects that the coordinate moves from a display region of the arbitrary page to a display region of the next page, the control section further erases an image rendered on the arbitrary page and renders the image on the next page and performs setting of simplex printing.

10. The apparatus according to claim 9, wherein, if an image is not rendered on the arbitrary page, the control section erases an image rendered on the next page.

11. The apparatus according to claim 1, wherein, if a print preview image of a printing target arbitrary page and a next page of the arbitrary page is displayed in an open state and if the control section detects that the coordinate moves from a display region of the arbitrary page to a display region of the next page, the control section further erases an image rendered on the arbitrary page and renders the image on the next page and performs setting of duplex printing.

12. The apparatus according to claim 1, wherein the input section is an input device of a touch panel type.

13. An image forming apparatus comprising:
an image acquiring section configured to acquire a printing target image;
an input section;
a display section configured to display a print preview image on which a predetermine marking is rendered and the printing target image acquired by the image acquiring section is rendered;
a control section configured to acquire, from the input section, a coordinate designated by predetermined operation by a user in a display region of the display section and, if the control section detects that the coordinate moves from a rendering region of the predetermined marking, display a preceding page or a next page of a page currently displayed as the print preview image; and
a printing section configured to form the printing target image acquired by the image acquiring section on a sheet as indicated by the print preview image displayed by the display section.

14. The apparatus according to claim 13, wherein
the display section further displays a list of printing target images, and
if the control section detects that the coordinate acquired from the input section moves from a region of a printing target image in the list to the print preview image region, the control section renders the printing target image on the print preview image.

15. The apparatus according to claim 14, wherein
if a page of a currently-displayed print preview image, which is a print preview image on which a printing target image is rendered, is an even number page, the control section performs setting of duplex printing and, if the page of the print preview image is an odd number page and a printing target image is not rendered on a print preview image equivalent to a rear side of the print preview image, the control section further performs setting of simplex printing, and
the printing section further prints the printing target image to match the setting of the duplex printing or the simplex printing set by the control section.

16. The apparatus according to claim 13, wherein
if the control section detects that the coordinate moves to above or below the rendering region of the predetermined marking, the control section controls display to display the print preview image in a longitudinal opening state and, if the control section detects that the coordinate moves to a left direction or a right direction of the rendering region of the predetermined marking, the control section controls display to display the print preview image in a lateral opening state, and
the printing section prints the printing target image to match the longitudinal opening or the lateral opening displayed by the display section.

17. The apparatus according to claim 13, wherein, if a print preview image for two pages in a printing target sheet is displayed in a lateral opening state and if the control section detects that the coordinate moves from a display region of one page of the two pages to above or below a display region of the other page, the control section further controls display to display the print preview image in a longitudinal opening state.

18. The apparatus according to claim 13, wherein, if a print preview image for two pages in a printing target sheet is displayed in a longitudinal opening state and if the control section detects that the coordinate moves from a display region of one page of the two pages to a right side or a left side of a display region of the other page, the control section further controls display to display the print preview image in a lateral opening state.

19. The apparatus according to claim 13, wherein
if a print preview image of an arbitrary page and a next page of the arbitrary page is displayed in an open state and if the control section detects that the coordinate moves from a display region of the arbitrary page to a display region of the next page, the control section further erases an image rendered on the arbitrary page and renders the image on the next page and performs setting of simplex printing, and
if the control section detects that the coordinate moves from the display region of the next page to the display region of the arbitrary page, the control section erases an image rendered on the next page and renders the image on the arbitrary page and performs setting of duplex printing.

20. A print preview display method comprising:
displaying a print preview image on which a predetermined marking is rendered; and
acquiring, from an input section, a coordinate designated by predetermined operation by a user in a display region and, if it is detected that the coordinate moves from a rendering region of the predetermined marking, displaying a preceding page or a next page of a page currently displayed as the print preview image.
